(19) United States
(12) Patent Application Publication
(10) Pub. No.: US 2008/0286704 A1
(43) Pub. Date: Nov. 20, 2008

(54) Method of burning a nitrogen-containing fuel

(76) Inventors: Hermann Bruggendick, Schermbeck (DE); Andreas Hospital, Duisburg (DE)

Correspondence Address: ROBERT W. BECKER & ASSOCIATES, 707 HIGHWAY 333, SUITE B, TIJERAS, NM, 87059-7507, US

(21) Appl. No.: 11/879,212

(22) Filed: Jul. 16, 2007

Related U.S. Application Data
(63) Continuation-in-part of application No. 09/856,342, filed on Aug. 22, 2001, now abandoned.

(30) Foreign Application Priority Data
Nov. 18, 1998 (DE) P 198 53 162.1
Oct. 22, 1999 (EP) PCT/EP1999/008040

(51) Int. Cl. F23J 7/00; B01D 53/56

(52) U.S. Cl. 431/4

(57) ABSTRACT

In a method of burning a nitrogen-containing fuel while reducing the emission of nitrogen oxides is provided, a sub-stoichiometric primary zone in the form of a flame core is produced and is supplied with a nitrogen oxide reducing agent that is a nitrogen compound or a hydrocarbon. Preferably, the flame core consists of a single zone and has a uniform air to fuel ratio.

### CROSS REFERENCE

The present application is a continuation-in-part of co-pending U.S. application Ser. No. 09/856,342.

### BACKGROUND OF THE INVENTION

The present invention relates to a method for operating a combustion plant while reducing the quantity of nitrogen oxides. More specifically, the invention relates to a method of burning a nitrogen-containing fuel.

Reducing emissions of pollutants when fossil fuels are burned is important in terms of environmental protection. Particularly critical are those pollutants that can neither be filtered out nor washed out. Among these are nitrogen oxides, primarily NO and NO₂. A differentiation should be made between nitrogen oxides that form thermally, that form based on atmospheric nitrogens, and those nitrogen oxides that result from fuel nitrogen. Thermal nitrogen oxides occur largely at temperatures above 1400° C. Their occurrence can be controlled in certain processes by appropriately controlling the temperature. In contrast, nitrogen oxides that are based on fuel nitrogen form even at low combustion temperatures.

The SCR method is primarily used by large-scale commercial plants for reducing emissions of nitrogen oxide. SCR stands for Selective Catalytic Reduction. A reducing agent is added and the spent combustion gas beyond the burnout zone is conducted through a catalytic reactor in which the nitrogen oxides are split up at temperatures of 300-400° C. and molecular nitrogen is formed. The capital investment required for the catalytic reactor is substantial. In addition, operating costs are high since the catalyzers have to be cleaned and reconditioned.

Also known is the SNCR method. SNCR stands for Selective Non-Catalytic Reduction. In this method, the reducing agent is introduced directly after the burnout zone into the super-stoichiometric spent combustion gas that is at a higher temperature. The same reactions take place as in the catalytic reactor, but without a catalyzer at a higher temperature and with less of a loss in pressure. A temperature window must be maintained that is between 950 and 1050° C. Above this temperature window there is the risk that the reducing agent will oxidize to nitrogen oxides in the presence of the prevailing excess oxygen. Below this temperature window the desired reactions do not occur on a large enough scale. The reducing agent slips, that is, the reducing agent is carried away by the combustion gas as an ineffective inert. In addition, the efficiency of the SNCR method requires the reducing agent to be mixed very intensively and uniformly, for instance with lances and the like, using a propellant with the spent combustion gas. This method is thus not suitable for large-scale commercial use. Its application is limited to smaller combustion plants, for instance to combined heat and power stations and garbage incineration plants. Large-scale commercial use would require mixing via a cross-section of 100-500 m² to be performed identically, which is effectively impossible.

The difficulties involved with mixing the reducing agent intensively and uniformly into the stream of combustion gas also have a negative effect on the high-temperature method currently in development. In this case, the reducing agent is introduced into a reduction zone that is situated between the burner zone and the burnout zone. Burner zone and reduction zone are operated sub-stoichiometrically. It can be necessary to work with fuel graduation, that is, to add a residual part of the fuel to the reduction zone. A carrier medium is required for adding the reducing agent. Air is not suitable since the reduction zone must remain sub-stoichiometric. Nitrogen is expensive. That leaves water vapor and liquids that can be evaporated, whereby the efficiency of the process drops in both cases. The same holds true for adding ammonia water, whose evaporating water portion is approximately 75%. In the burnout zone, which is adjacent to the reduction zone, the air factor becomes greater than 1 due to the addition of additional combustion air.

The portion of resultant NO is comparatively low due to the lack of oxygen in the reduction zone. When the reducing agent is added, the NO is split up and molecular nitrogen is formed.

In addition to the problems associated with mixing the reducing agent uniformly and intensively into the reduction zone, there are regulation problems, as well. The burner zone naturally becomes shorter when there is a change in load. The reduction zone must therefore be moved closer to the burners. When the load is increased, it is necessary to prevent the reduction zone from migrating into the burnout zone and coming into contact there with additional combustion air, which would bring about super-stoichiometric conditions.

### SUMMARY OF THE INVENTION

The object of the present invention is to provide a method of the type cited in the foregoing that is suitable for large-scale commercial employment in a more efficient and more reliable manner with lower capital and operating costs.

For achieving this object, the method cited in the foregoing is inventively characterized in that a sub-stoichiometric flame zone is produced and in that the nitrogen oxide reducing agent is introduced into the sub-stoichiometric flame zone. The sub-stoichiometric primary zone that is produced is preferably in the form of a flame core that is produced from all of the fuel and primary air. The sub-stoichiometric primary zone that forms the flame core preferably is made up of only a single zone, rather than two or more zones, and has a uniform air to fuel ratio. In a further step, the flame core is supplied with a nitrogen oxide reducing agent so that the reducing agent is distributed within the flame core

The sub-stoichiometric flame zone has a comparatively small cross-section, so there is no problem distributing the reducing agent uniformly via this cross-section. Changes in load do not affect this, either.

Furthermore, the method in accordance with the invention has none of the temperature limitations that affect the SNCR method. On the contrary, it has proved to be particularly advantageous to adjust the temperature in the sub-stoichiometric flame zone to over 1100° C.

Ammonia is generally selected for the reducing agent; ammonia water, urea, and other nitrogen compounds can also be used, as well as hydrocarbons, especially natural gas (CH₄). Practically the entire quantity of available oxygen is used for partially oxidizing the carbon in the sub-stoichiometric flame zone. Only a small amount of NO occurs. The presence of the reducing agent ensures that the concentration of the radicals NHi, CHi, and HCN increases. These radicals react with the nitrogen monoxide that has occurred, reduce it, and thus permit molecular nitrogen to occur.

The temperature of the process should preferably be controlled such that upon later burnout, that is, when air is added subsequently, the nitrogen molecules that have occurred (as well as the N₂ molecules in the combustion air) do not break down thermally and form nitrogen oxides. This means that the temperature should not rise above 1400° C.

There is no negative effect if too much reducing agent is employed. Thus, no reducing agent slip can occur because the reducing agent is completely converted during the subsequent burnout when oxygen is added. This means that the residual substances (flue ash and gypsum) can be disposed of with no limitations.

In a substantial further development of the invention, it is suggested that the sub-stoichiometric flame zone be produced as a flame core from fuel and primary air, preferably all available fuel and primary air, and be enveloped with a veil of secondary air, preferably also with another veil of tertiary air. The break-down and reduction of the NO thus take place in the sub-stoichiometric flame core. The veils of secondary air, and preferably of tertiary air, then ensure that the fuel burns out and the excess reducing agent breaks down. The combustion gas thus does not come into contact with the surrounding walls when in the sub-stoichiometric state. This effectively prevents the occurrence of high temperature corrosion, which is another major advantage of the present invention.

The nitrogen oxide reducing agent can be introduced into the sub-stoichiometric flame zone through lateral or central lances. However, it is preferably introduced into the sub-stoichiometric flame zone together with the fuel. Furthermore, it can be advantageous to introduce the nitrogen oxide reducing agent into the sub-stoichiometric flame zone together with the primary air. If necessary, the fuel is already mixed with the primary air or a portion of the primary air. In this case the mixture comprises fuel, primary air, and reducing agent.

Furthermore, it is possible to blow into the flame at least a portion of the primary air as core air, whereby this preferably occurs together with the nitrogen oxide reducing agent.

The present invention develops its advantages preferably wherever the fuel has a high nitrogen content. This is the case, for instance, in bituminous coal, tar oil, heavy oil, residual oil, process gas, and the like. Solid fuels are ground prior to combustion. The reducing agent can be in solid form (also ground) or can also be liquid or gaseous. The method is suitable for all levels of output and works without any additional loss in pressure.

The present invention's main area of application is power plant engineering. The burners are arranged in a plurality of planes one above the other to the side in the boiler wall, whereby the cross-section of the boiler can be 100-500 m². Air from above is blown in above the uppermost burner plane. Each burner is an independent sub-stoichiometric NO reduction system and delivers super-stoichiometric combustion gases to the boiler. As can be seen, there is no problem with turning individual burner planes on or off.

The specification incorporates by reference the disclosure of German priority documents 198 53 162.1 of 18 Nov. 1998 and PCT/EP99/08040 of 22 Oct. 1999.

The present invention is, of course, in no way limited to the specific disclosure of the specification and drawings, but also encompasses any modifications within the scope of the appended claims.

1. A method of burning a nitrogen-containing fuel while reducing the emission of nitrogen oxides, said method including the steps of:
producing a flame core from all of the fuel and primary air, wherein said flame core comprises a sub-stoichiometric primary zone having a uniform air to fuel ratio; and
supplying said flame core with a nitrogen oxide reducing agent so that said reducing agent is distributed within said flame core, wherein said reducing agent is a nitrogen compound or a hydrocarbon.

2. The method according to claim 1, wherein the sub-stoichiometric primary zone that forms the flame core comprises only a single zone.

3. A method according to claim 1, wherein a temperature of greater than 1100° C. is established in said sub-stoichiometric flame core.

4. A method according to claim 1, wherein said sub-stoichiometric flame core is enveloped within a veil of secondary air.

5. A method according to claim 1, wherein said nitrogen oxide reducing agent is introduced into said sub-stoichiometric flame core mixed together with the fuel.

6. A method according to claim 1, wherein said nitrogen oxide reducing agent is introduced into said sub-stoichiometric flame core mixed together with the primary air.

7. A method according to claim 1, wherein said nitrogen oxide reducing agent is a nitrogen compound comprising at least one compound selected from the group consisting of ammonia, ammonia water, and urea.

8. A method according to claim 1, wherein said nitrogen oxide reducing agent is a hydrocarbon compound comprising at least one compound selected from the group consisting of natural gas and methane.

9. A method according to claim 4, wherein said veil of secondary air is enveloped within a further veil of tertiary air.

10. A method according to claim 1, wherein supplying said flame core with a nitrogen oxide reducing agent so that said reducing agent is distributed within said flame core includes supplying said flame core with a nitrogen oxide reducing agent so that said reducing agent is uniformly distributed within said flame core.
